(19) United States
(12) Patent Application Publication
(10) Pub. No.: US 2008/0174867 A1
(43) Pub. Date: Jul. 24, 2008

(54) OPTICAL ELEMENT AND PROJECTOR

(75) Inventor: Masakazu KAWAMURA, Mastumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/876,445

(22) Filed: Oct. 22, 2007

(30) Foreign Application Priority Data
Nov. 30, 2006 (JP) 2006-323116

(51) Int. Cl. G02B 27/28

(52) U.S. Cl. 359/485

(57) ABSTRACT

An optical element includes a first rod section that converts an incident light flux into a light flux having a more uniform in-plane light intensity distribution, a reflective polarization beam splitter that reflects a light flux related to one linearly polarization component of light fluxes from the first rod section and transmits a light flux related to the other linearly polarization component, and a second rod section that converts the light flux transmitted through the reflective polarization beam splitter into a light flux having a more uniform in-plane intensity distribution.

### BACKGROUND

1. Technical Field

The present invention relates to an optical element and a projector.

2. Related Art

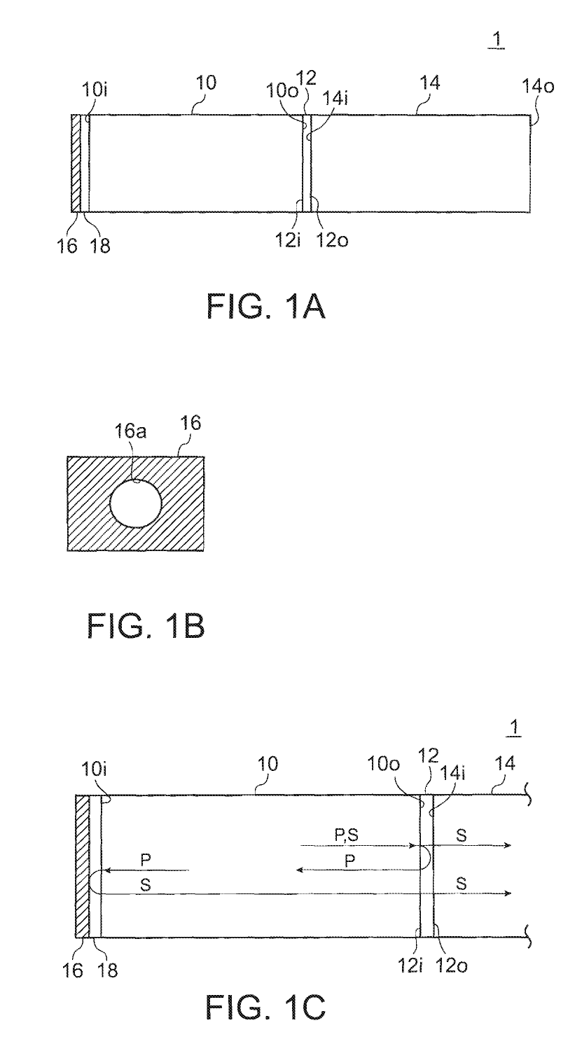

Various projectors including optical elements having rod sections and polarization converting sections nave been proposed as a projector including an electro-optic modulator (e.g., a liquid crystal device) that uses polarized light (see, for example, JP-A-2000-56266, JP-A-2002-268008, and JP-T-2004-507774 (FIG. 1) (the term “JP-T” as used herein means a published Japanese translation of a PCT patent application))

The projector of the past disclosed in JP-A-2000-56266 includes an optical element in which a rod section is arranged at a subsequent stage of a polarization converting section. Thus, it is possible to convert an illuminating light flux emitted from the polarization converting section into an illuminating light flux having a more uniform in-plane light intensity distribution according to multiple reflection on an inner surface of the rod section. On the other hand, even if an illuminating light flux from a light source device is converted into one kind of linearly polarization by a function of the polarization converting section, the linearly polarization is multiple-reflected on the inner surface of the rod section. Thus, a polarization degree of an illuminating light flux emitted from the optical element (the rod section) deteriorates.

The projector of the past disclosed in JP-A-2002-268008 includes an optical element in which a polarization converting section is arranged at a subsequent stage of a rod section. Thus, it is possible to convert an illuminating light flux from the rod section into one kind of linearly polarization according to a function of the polarization converting section. On the other hand, local nonuniformity of light is present in a boundary portion between an area of a light emitting surface of the polarization converting section through which a light flux transmitted through a polarization beam splitting layer passes and an area of a light emitting surface of the polarization converting section through which a light flux reflected on the polarization beam splitting layer and further reflected on a reflection layer passes. Thus, uniformity of an illuminating light flux emitted from the optical element (the polarization converting section) deteriorates.

The projector of the past disclosed in JP-T-2004-507774 includes an optical element in which a polarization converting section is arranged between a first rod section and a second rod section. The polarization converting section has a polarization beam splitting surface that transmits a light flux related to one linearly polarization component of light fluxes from the first rod section and reflects a light flux related to the other linearly polarization component, a λ/2 plate that converts the light flux related to the other linearly polarization component reflected on the polarization beam splitting surface into the light flux related to one linearly polarization component, and a reflection surface that reflects the light flux related to one linearly polarization component having passed through the λ/2 plate in a direction same as a direction in which the light flux related to on e linearly polarization component transmitted through the polarization beam splitting surface travels.

Therefore, in the projector of the past disclosed in JP-T-2004-507774, if it is possible to once secure light uniformity to some degree in the first rod, it is unnecessary to set the length of the second rod section so large. As a result, a polarization degree of the illuminating light flux emitted from the optical element does not deteriorate to be as low as that of the projector of the past disclosed in JP-A-2000-56266.

Further, in the projector of the past disclosed in JP-T-2004-507774, even if local nonuniformity of light is present in a boundary portion between an area of a light emitting surface of the polarization converting section through which a light flux transmitted through the polarization beam splitting layer passes and an area of a light emitting surface of the polarization converting section through which a light flux reflected on the polarization beam splitting layer and further reflected on the reflection layer passes, it is possible to convert an illuminating light flux emitted from the polarization converting section into an illuminating light flux having a more uniform in-plane light intensity distribution according to multiple reflection on an inner surface of the second rod section. As a result, uniformity of the illuminating light flux emitted from the optical element does not deteriorate to be as low as that of the projector of the past disclosed in JP-A-2002-2680028.

Therefore, it can be said that the projector disclosed in JP-T-2004-507774 is a projector that is capable of controlling a polarization degree and uniformity of the illuminating light flux emitted from the optical element as much as possible.

However, in the projector of the past disclosed in JP-T-2004-507774, in aligning polarization directions of light fluxes in one direction, it is necessary to separate an optical path into two with the polarization beam splitting surface in the polarization converting section. Thus, a size of the light emitting surface of the polarization converting section is about twice as large as a light incident surface of the polarization converting section. Therefore, a size of a light incident surface of the second rod section is about twice as large as a light emitting surface of the first rod section. This makes it less easy to realize a reduction in size of the optical element.

Further, in the projector of the past disclosed in JP-T-2004-507774, since a structure for performing polarization conversion is complicated, it is not easy to manufacture the optical element.

### SUMMARY

An advantage of some aspects of the invention is to provide an optical element and a projector that are easily reduced in size and easily manufactured while reducing the deterioration in a polarization degree and uniformity of a light flux emitted from the optical element as much as possible.

According to an aspect of the invention, there is provided an optical element including a first rod section that converts an incident light flux into a light flux having a more uniform in-plane light intensity distribution, a reflective polarization beam splitter that reflects a light flux related to one linearly polarization component of light fluxes from the first rod section and transmits a light flux related to the other linearly polarization component, and a second rod section that converts the light flux transmitted through the reflective polarization beam splitter into a light flux having a more uniform in-plane intensity distribution.

Therefore, in the optical element according to the aspect of the invention if it is possible to once secure light uniformity to some degree in the first rod section, it is unnecessary to set the length of the second rod section so large. As a result, a polarization degree of an illuminating light flux emitted from the optical element does not deteriorate to be as low as that of the optical element disclosed in JP-A-2000-56266.

In the optical element according to the aspect of the invention, the reflective polarization beam splitter is adopted as a component for performing polarization conversion rather than the polarization converting section including the polarization beam splitting surface, the λ/2 plate, and the reflection surface. Thus, the local nonuniformity of light described above is not present on a light emitting surface of the reflective polarization beam splitter. As a result, it is possible to reduce the deterioration in uniformity of an illuminating light flux emitted from the optical element.

In the optical element according to the aspect of the invention, since polarization directions of light fluxes are aligned in one direction using the reflective polarization beam splitter, naturally the light emitting surface of the reflective polarization beam splitter and a light incident surface of the reflective polarization beam splitter are formed in the same size. Thus, a size of a light incident surface of the second rod section is the same as a size of a light emitting surface of the first rod section. As a result, it is easy to realize a reduction in size of the optical element.

In the optical element according to the aspect of the invention, the reflective polarization beam splitter is adopted as a component for performing polarization conversion rather than the polarization converting section including the polarization beam splitting surface, the λ/2 plate, and the reflection surface. Thus, a structure for performing polarization conversion is not complicated. As a result, it is relatively easy to manufacture the optical element.

Therefore, the optical element according to the aspect of the invention is an optical element that is easily reduced in size and easily manufactured while reducing the deterioration in a polarization degree and uniformity of a light flux emitted from the optical element as much as possible.

Preferably, the optical element according to the aspect of the invention further includes a reflection mirror that is arranged on a light incidence side of the first rod section and has an opening for light incidence in the center thereof and a λ/4 plate that is arranged between the reflection mirror and the first rod section.

With such a structure, it is possible to reflect, with the reflection mirror, a light flux related to one linearly polarization component reflected on the reflective polarization beam splitter to the reflective polarization beam splitter. In this case, the light flux related to one linearly polarization component reflected on the reflective polarization beam splitter passes through the λ/4 plate twice until the light flux reaches the reflective polarization beam splitter. Thus, a polarization direction rotates 90 degrees and the light flux is converted into a light flux related to the other linearly polarization component. When the light flux reaches the reflective polarization beam splitter again, the light flux passes through the reflective polarization beam splitter. Therefore, it is possible to use the light flux reflected on the reflective polarization beam splitter and improve efficiency of light usage.

Preferably, the optical element according to the aspect of the invention further includes a reflection mirror that is arranged on a light incidence side of the first rod section and has an opening for light incidence in the center thereof.

with such a structure, it is possible to reflect, with the reflection mirror, a light flux related to one linearly polarization component reflected on the reflective polarization beam splitter to the reflective polarization beam splitter. In this case, a part of a light flux related to one linearly polarization component reflected on the reflective polarization beam splitter is reflected on an inner surface of the first rod section and the reflection mirror to be converted into a light flux related to the other linearly polarization component. When the light flux reaches the reflective polarization beam splitter again, the light flux passes through the reflective polarization beam splitter. Therefore, it is possible to use the light flux reflected on the reflective polarization beam splitter and improve efficiency of light usage.

Preferably, the optical element according to the aspect of the invention further includes a second reflective polarization beam splitter that is arranged on an light incidence side of the first rod section, has an opening for light incidence in the center thereof, and transmits a light flux related to one linearly polarization component of light fluxes reflected on the reflective polarization beam splitter and reflected on an inner surface of the first rod section and reflects a light flux related to the other linearly polarization component.

As described above, a part of the light flux related to one linearly polarization component reflected on the reflective polarization beam splitter is reflected on the inner surface of the first rod section to be converted into the light flux related to the other linearly polarization component. Thus, with such a structure, it is possible to reflect, with the second reflective polarization beam splitter, a part of the light flux reflected on the reflective polarization beam splitter to the reflective polarization beam splitter. When the light flux related to the other linearly polarization component reflected on the second reflective polarization beam splitter reaches the reflective polarization beam splitter again, the light flux passes through the reflective polarization beam splitter. Therefore, it is possible to use the light flux reflected on the reflective polarization beam splitter and improve efficiency of light usage.

A projector according to another aspect of the invention includes the optical element according to the aspect of the invention.

Therefore, the projector according to another aspect of the invention is an excellent projector that includes an optical element that is easily reduced in size and easily manufactured while reducing the deterioration in a polarization degree and uniformity of a light flux emitted from the optical element as much as possible.

BRIEF DESCRIPTION OF THE DRAWINGS

The invention will be described with reference to the accompanying drawings, wherein like numbers reference like elements.

FIGS. 1A to 1C are diagrams for explaining an optical element 1 according to a first embodiment of the invention.

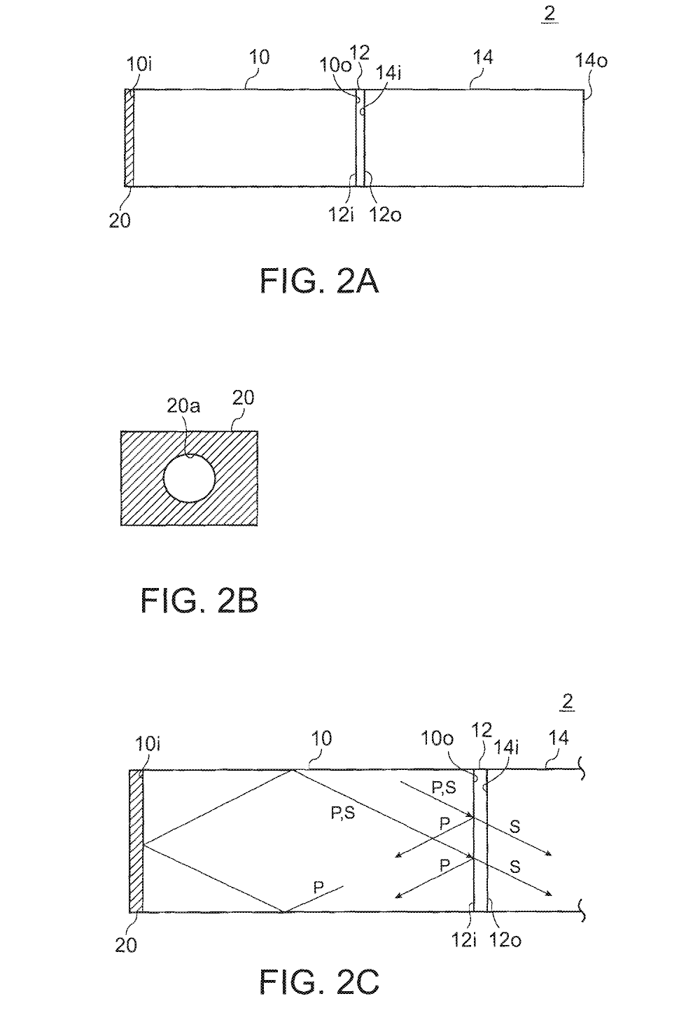

FIGS. 2A to 2C are diagrams for explaining an optical element 2 according to a second embodiment of the invention.

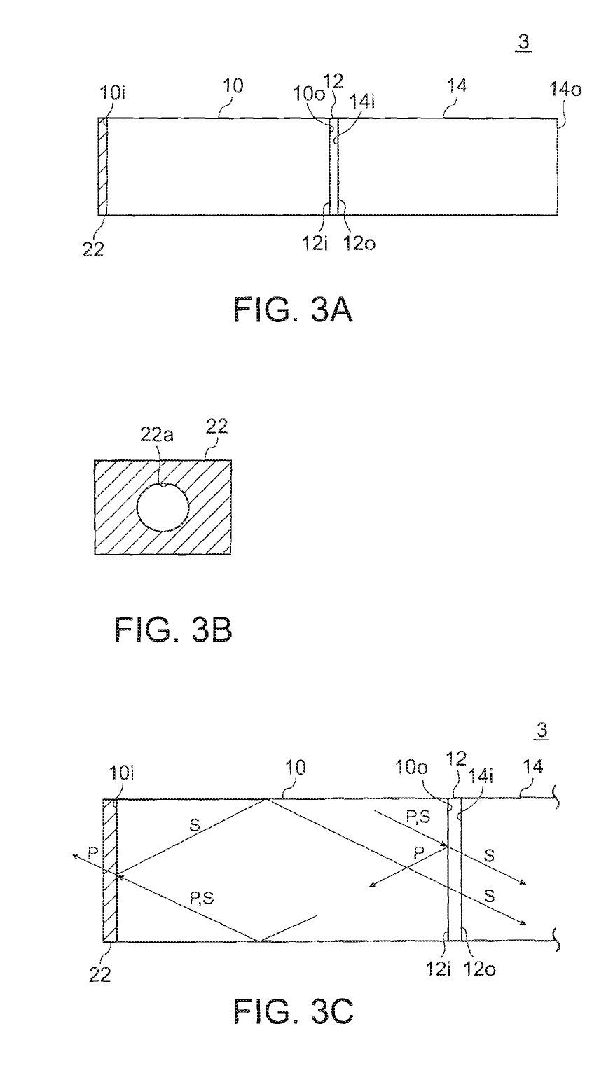

FIGS. 3A to 3C are diagrams for explaining an optical element 3 according to a third embodiment of the invention.

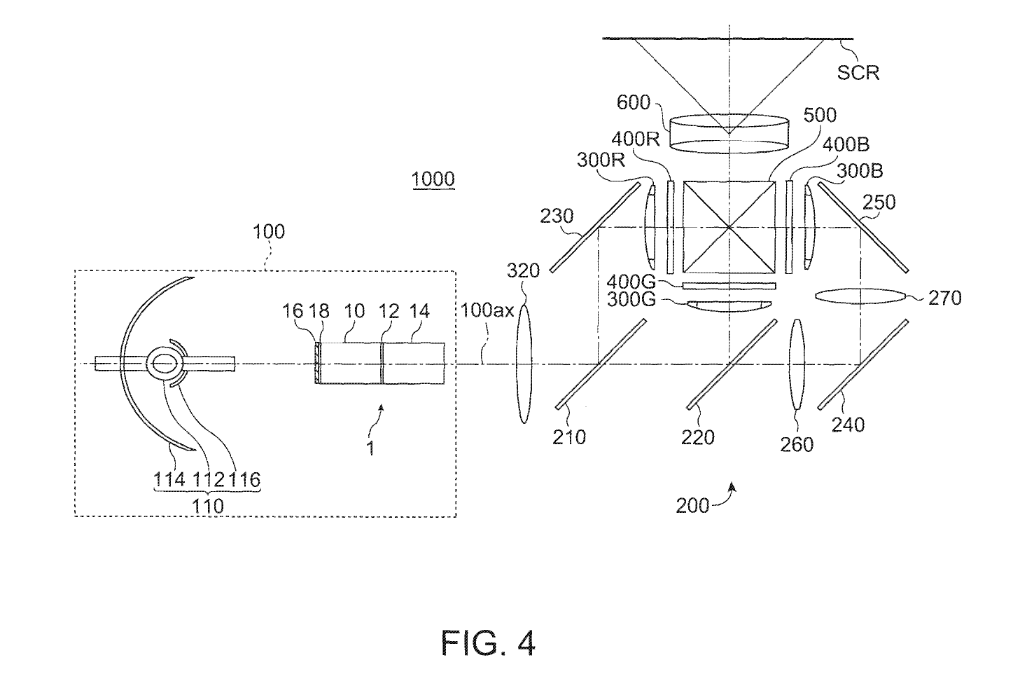

FIG. 4 is a diagram showing an optical system of a projector 1000 according to a fourth embodiment of the invention.

### DESCRIPTION OF EXEMPLARY EMBODIMENTS

An optical element and a projector according to exemplary embodiments of the invention will be hereinafter explained with reference to the drawings. First to third embodiments of the invention relate to the optical element and a fourth embodiment relates to the projector.

### FIRST EMBODIMENT

FIGS. 1A to 1C are diagrams for explaining an optical element 1 according to a first embodiment of the invention. FIG. 1A is a side view of the optical element 1, FIG. 1B is a front view of the optical element 1, and FIG. 1C is a schematic diagram for explaining a polarization converting function of the optical element 1.

As shown in FIGS. 1A to 1C, the optical element 1 according to the first embodiment includes a first rod section 10 that converts an incident light flux into a light flux having a more uniform in-plane light intensity distribution, a reflective polarization beam splitter 12 that reflects a light flux related to one linearly polarization component (a P polarized light component) of light fluxes from the first rod section 10 and transmits a light flux related to the other linearly polarization component (an S polarized light component), a second rod section 14 that converts the light flux transmitted through the reflective polarization beam splitter 12 into a light flux having a more uniform in-plane light intensity distribution, a reflection mirror 16 that is arranged on a light incidence side of the first rod section 10, and a λ/4 plate 18 that is arranged between the reflection mirror 16 and the first rod section 10.

The first rod section 10 is an optical member that has a function of multiple-reflecting a light flux made incident on the first rod section 10 on an inner surface thereof to convert the incident light flux into a light flux having a more uniform n-plane light intensity distribution. As the first rod section 10, it is possible to suitably use, for example, a solid glass rod.

The reflective polarization beam splitter 12 has a function of reflecting a light flux related to one linearly polarization component (a P polarized light component) of light fluxes from the first rod section 10 and transmits a light flux related to the other linearly polarization component (an S polarized light component) to align polarization directions of the light fluxes emitted from the reflective polarization beam splitter 12 in a polarization direction of the light flux related to the other linearly polarization component (the S polarized light component).

As the reflective polarization beam splitter 12, it is possible to suitably use for example, a reflection inorganic polarization plate of a wire grid type in which a large number of fine metal thin wires are arrayed.

The second rod section 14 is an optical member that has a function of multiple-reflecting a light flux transmitted through the reflective polarization beam splitter 12 on an inner surface thereof to convert the light flux into a light flux having a more uniform in-plane light intensity distribution. As the second rod section 14, it is possible to suitably use a solid glass rod.

The reflection mirror 16 is arranged on the light incidence side of the first rod 10 and has an opening 16a for light incidence in the center thereof (see FIG. 1B). The reflection mirror 16 reflects a light flux reflected on the reflective polarization beam splitter 12 and having passed through the λ/4 plate 18 to the reflective polarization beam splitter 12.

As the λ/4 plate 18, it is possible to suitably use, for example, a plate made of a crystal material such as calcite or quartz. A plate of a film type formed by holding a stretched PVA (polyvinyl alcohol) film with a TAC (triacetyl cellulose) film or the like may be used.

In the optical element 1 according to the first embodiment constituted as described above, if it is possible to once secure light uniformity to some degree in the first rod section 10, it is unnecessary to set the length of the second rod section 14 so large. As a result, a polarization degree of an illuminating light flux emitted from the optical element 1 does not deteriorate to be as low as that of the optical element disclosed in JP-A-2000-56266.

In the optical element 1 according to the first embodiment, the reflective polarization beam splitter 12 is adopted as a component for performing polarization conversion rather than the polarization converting section including the polarization beam splitting surface, the λ/2 plate, and the reflection surface. Thus, the local nonuniformity of light described above is not present on a light emitting surface 12o of the reflective polarization beam splitter 12. As a result, it is possible to reduce the deterioration in uniformity of an illuminating light flux emitted from the optical element 1.

In the optical element 1 according to the first embodiment, polarization directions of light fluxes are aligned in one direction using the reflective polarization beam splitter 12. Thus, naturally, the light emitting surface 12o of the reflective polarization beam splitter 12 and a light incident surface 12i of the reflective polarization beam splitter 12 are formed in the same size. Therefore, a size of a light incident surface 14i of the second rod section 14 is the same as a size of a light emitting surface 10o of the first rod section 10. As a result, it is easy to realize a reduction in size of the optical element 1.

In the optical element 1 according to the first embodiment, the reflective polarization beam splitter 12 is adopted as a component for performing polarization conversion rather than the polarization converting section including the polarization beam splitting surface, the λ/2 plate, and the reflection surface. Thus, a structure for performing polarization conversion is not complicated. As a result, it is relatively easy to manufacture the optical element 1.

Therefore, the optical element 1 according to the first embodiment is an optical element that is easily reduced in size and easily manufactured while reducing the deterioration in a polarization degree and uniformity of a light flux emitted from the optical element 1 as much as possible.

The optical element 1 according to the first embodiment further includes the reflection mirror 16 and the λ/4 plate 18 as described above. Thus, it is possible to reflect, with the reflection mirror 16, a light flux related to one linearly polarization component (a P polarized light component) reflected on the reflective polarization beam splitter 12 to the reflective polarization beam splitter 12. In this case, as shown in FIG. 1C, the light flux related to one linearly polarization component (the P polarized light component) reflected on the reflective polarization beam splitter 12 passes through the λ/4 plate 18 twice until the light flux reaches the reflective polarization beam splitter 12. Thus, a polarization direction rotates 90 degrees and the light flux is converted into a light flux related to the other linearly polarization component (an S polarized light component). When the light flux reaches the reflective polarization beam splitter 12 again, the light flux passes through the reflective polarization beam splitter 12. Therefore, it is possible to use the light flux reflected on the reflective polarization beam splitter 12 and improve efficiency of light usage.

In the optical element 1 according to the first embodiment, the optical components (the reflection mirror 16, the λ/4 plate 18, the first rod section 10, the reflective polarization beam splitter 12, and the second rod section 14) are bonded to one another. Thus, undesirable multiple reflection among the optical components is reduced and the deterioration in the efficiency of light usage and the rise in a stray light level do not occur. Further, it is possible to easily integrate the optical components. Moreover, it is possible to prevent positional deviation after assembly of an apparatus from occurring among the optical components.

### SECOND EMBODIMENT

FIGS. 2A to 2C are diagrams for explaining an optical element 2 according to a second embodiment of the invention. FIG. 2A is a side view of the optical element 2, FIG. 2B is a front view of the optical element 2, and FIG. 2C is a schematic diagram for explaining a polarization converting function of the optical element 2. In FIGS. 2A to 2C, members identical with those in FIGS. 1A to 1C are denoted by the identical reference numerals and signs and detailed explanations of the members are omitted.

The optical component 2 according to the second embodiment basically has a structure similar to that of the optical element 1 according to the first embodiment. However, the optical element 2 according to the second embodiment is different from the optical element 1 according to the first embodiment in a member arranged on the light incidence side of the first rod section.

In the optical element 2 according to the second embodiment, as shown in FIGS. 2A to 2C, a reflection mirror 20 having an opening 20a for light incidence in the center thereof is arranged on the light incidence side of the first rod section 10. The reflection mirror 20 reflects a light flux reflected on the reflective polarization beam splitter 12 and reflected on the inner surface of the first rod section 10 to the reflective polarization beam splitter 12.

In this way, the optical element 2 according to the second embodiment is different from the optical element 1 according to the first embodiment in the member arranged on the light incidence side of the first rod section. However, as in the case of the optical element 1 according to the first embodiment, the optical element 2 according to the second embodiment includes the first rod section 10, the reflective polarization beam splitter 12, and the second rod section 14. Thus, the optical element 2 according to the second embodiment is an optical element that is easily reduced in size and easily manufactured while reducing the deterioration in a polarization degree and uniformity of a light flux emitted from the optical element as much as possible.

The optical element 2 according to the second embodiment further includes the reflection mirror 20 as described above. Thus, it is possible to reflect, with the reflection mirror 20, a light flux related to one linearly polarization component (a P polarized light component) reflected on the reflective polarization beam splitter 12 to the reflective polarization beam splitter 12. In this case, as shown in FIG. 2C, a part of the light flux related to one linearly polarization component (the P polarized light component) reflected on the reflective polarization beam splitter 12 is reflected on the inner surface of the first rod section 10 and the reflection mirror 20 to be converted into a light flux related to the other linearly polarization component (an S polarized light component). When the light flux reaches the reflective polarization beam splitter 12 again, the light flux passes through the reflective polarization beam splitter 12. Therefore, it is possible to use the light flux reflected on the reflective polarization beam splitter 12 and improve efficiency of tight usage.

The optical element 2 according to the second embodiment has the same structure as the optical element 1 according to the first embodiment except that the member arranged on the light incidence side of the first rod section is different. Thus, the optical element 2 according to the second embodiment has effects corresponding to the structure thereof among the effects of the optical element 1 according to the first embodiment.

### THIRD EMBODIMENT

FIGS. 3A to 3C are diagrams for explaining an optical element 3 according to a third embodiment of the invention. FIG. 3A is a side view of the optical element 3, FIG. 3B is a front view of the optical element 3, and FIG. 3C is a schematic diagram for explaining a polarization converting function of the optical element 3. In FIGS. 3A to 3C, members identical with those in FIGS. 1A to 1C are denoted by the identical reference numerals and signs and detailed explanations of the members are omitted.

The optical component 3 according to the third embodiment basically has a structure similar to that of the optical element 1 according to the first embodiment. However, the optical element 3 according to the third embodiment is different from the optical element 1 according to the first embodiment in a member arranged on the light incidence side of the first rod section.

In the optical element 3 according to the third embodiment, as shown in FIG. 3A to 3C, a second reflective polarization beam splitter 22 is arranged on the light incidence side of the first rod section 10. The second reflective polarization beam splitter 22 has an opening 22a for light incidence in the center thereof and transmits a light flux related to one linearly polarization component (a P polarized light component) of light fluxes reflected on the reflective polarization beam splitter 12 and reflected on the inner surface of the first rod section 10 and reflects a light flux related to the other linearly polarization component (an S polarized light component). As the second reflective polarization beam splitter 22, it is possible to suitably use, for example, a reflection inorganic polarization plate of a wire grid type in which a large number of fine metal thin wires are arrayed.

In this way, the optical element 3 according to the third embodiment is different from the optical element 1 according to the first embodiment in the member arranged on the light incidence side of the first rod section. However, as in the case of the optical element 1 according to the first embodiment, the optical element 3 according to the third embodiment includes the first rod section 10, the reflective polarization beam splitter 12, and the second rod section 14. Thus, the optical element 3 according to the third embodiment is an optical element that is easily reduced nil size and easily manufactured while reducing the deterioration in a polarization degree and uniformity of a light flux emitted from the optical element as much as possible.

The optical element 3 according to the third embodiment further includes the second reflective polarization beam splitter 22 that transmits a light flux related to one linearly polarization component the P polarized light component) of light fluxes reflected on the reflective polarization beam splitter 12 and reflected on the inner surface of the first rod section 10 and reflects a light flux related to the other linearly polarization component (the S polarized light component).

As explained about the optical element 2 according to the second embodiment, a part of the light flux related to one linearly polarization component (the P polarized light component) reflected on the reflective polarization beam splitter 12 is reflected on the inner surface of the first rod section 10 to be converted into a light flux related to the other linearly polarization component (the S polarized light component). Thus, in the optical element 3 according to the third embodiment, it is possible to reflect, with the second reflective polarization beam splitter 22, a part of a light flux reflected on the reflective polarization beam splitter 12 to the reflective polarization beam splitter 12. When the light flux related to the other linearly polarization component (the S polarized light component) reflected on the second reflective polarization beam splitter 22 reaches the reflective polarization beam splitter 12 again, the light flux passes through the reflective polarization beam splitter 12. Therefore, it is possible to use the light flux reflected on the reflective polarization beam splitter 12 and improve efficiency of light usage.

The optical element 3 according to the third embodiment has the same structure as the optical element 1 according to the first embodiment except that the member arranged on the light incidence side of the first rod section is different. Thus, the optical element 3 according to the third embodiment has effects corresponding to the structure thereof among the effects of the optical element 1 according to the first embodiment.

### FOURTH EMBODIMENT

A structure of a projector 1000 according to a fourth embodiment of the invention will be explained with reference to FIG. 4. FIG. 4 is a diagram showing an optical, system of the projector 1000 according to the fourth embodiment.

As shown in FIG. 4, the projector 1000 according to the fourth embodiment is a projector including an illumination device 100, a color-separation light-guide optical system 200 that separates an illuminating light flux from the illumination device 100 into three color lights of a red lights a green light, and a blue light and guides the color lights to an illuminated area, three liquid crystal devices 400R, 400G, and 400B that modulate three color lights separated by the color-separation light-guide optical system 200 according to image information, respectively, a cross dichroic prism 500 that combines the color lights modulated by the three liquid crystal devices 400R, 400G, and 400B, and a projection optical system 600 that projects the light combined by the cross dichroic prism 500 on a projection surface of a screen SCR or the like.

The illumination device 100 includes a light source device 100 that emits an illuminating light flux to the illuminated area side and the optical element 1. The projector 1000 according to the fourth embodiment includes, as an optical element, the optical element 1 according to the first embodiment.

The light source device 110 includes an elliptical surface reflector 114, a light emitting tube 112 that has a light emission center near a first focal point of the elliptical surface reflector 114, and a sub-mirror 116 that reflects light emitted from the light emitting tube 1121 to the illuminated area side to the light emitting tube 112 The light source device 110 emits a light flux having an illuminating light axis 100ax as a center axis.

The light emitting tube 112 has a vessel section and a pair of sealing sections extending to both sides of the vessel section. The vessel section is made of a quartz glass formed in a spherical shape and has a pair of electrodes arranged in the vessel section and mercury, a rare gas, and a small quantity of halogen filled in the vessel section. As the light emitting tube 112, is possible to adopt various light emitting tubes. It is possible to adopt, for example, a metal hydride lamp, a high-pressure mercury lamp, and a super-high pressure mercury lamp .

The elliptical surface reflector 114 has a tubular neck-shaped section inserted in and fastened to one sealing section of the light emitting tube 112 and a reflection concave surface that reflects light emitted from the light emitting tube 112 to a second focus position.

The sub-mirror 116 is reflecting means that covers substantially a half of the vessel section of the light emitting tube 112 and is arranged to be opposed to the reflection concave surface of the elliptical surface reflector 114. The sub-mirror 116 is inserted in and fastened to the other sealing section of the light emitting tube 112. The sub-mirror 116 returns light not traveling to the elliptical surface reflector 114 of the light emitted from the light emitting tube 112 to the light emitting tube 112 and makes the light Incident on the elliptical surface reflector 114. The light reflected by the reflection concave surface of the sub-mirror 116 is made incident on the elliptical surface reflector 114 and, then, emitted to the second focus position by the elliptical surface reflector 114.

The optical element 1 is arranged such that the light incidence surface (the reflection mirror 16) is located near a second focal point of the elliptical surface reflector 114. Although not shown in the figure, an external shape of the light emitting surface (the light emitting surface 14o of the second rod section 14) of the optical element 1 is similar to an external shape of image formation areas of the liquid crystal devices 400R, 400G, and 400B.

Since a structure of the optical element 1 of the projector 1000 is the same as the structure of the optical element 1 according to the first embodiment, an explanation of the optical element 1 is omitted.

A release lens 320 is arranged between the illumination device 100 and the color-separation light-guide optical system 200. The release lens 320 has a, function of, in conjunction with condensing lenses 300R, 300G, and 300B, focusing an illuminating light flux from the illumination device 100 on areas near the image formation areas of the liquid crystal devices 400R, 400B, and 400B without causing the illuminating light flux to diverge.

The color-separation light-guide optical system 200 has dichroic mirrors 210 and 220, reflection mirrors 230, 240, and 250, an incidence side lens 260, and a release lens 270. The color-separation light-guide optical system 200 has a function of separating an illuminating light flux emitted from the release lens 320 into three color lights of a red light, a green light, and a blue light and guiding the light fluxes to the three liquid crystal devices 400R, 400G and 400B as illumination objects, respectively.

The liquid crystal devices 400R, 400G, and 400B modulate an illuminating light flux according to image information and are the illumination objects of the illumination device 100.

The liquid crystal devices 400R, 400G, and 400B are devices obtained by filling liquid crystal as an electrooptical substance in a space between a pair of transparent glass substrates and closing the space. For example, the liquid crystal devices 400R, 400G, and 400B modulate, with a polysilicon TFT as a switching element, polarization direction of one kind of linearly polarization emitted from incidence side sheet polarizers described later in accordance with given image information.

The condensing lenses 300R, 300G, and 300B are arranged at pre-stages on optical paths of the liquid crystal devices 400R, 400G, and 400B.

Although not shown in the figure, the incidence side sheet polarizers are interposed and arranged between the condensing lenses 300R, 300G, and 300B and the liquid crystal devices 400R, 400G, and 400B, respectively. Emission side sheet polarizers are interposed and arranged between the liquid crystal devices 400R, 400G, and 400B and the cross dichroic prism 500, respectively. The modulation of the incident respective color lights is performed by the incidence side sheet polarizers, the liquid crystal devices 400R, 400G, and 400B, and the emission side sheet polarizers.

The cross dichroic prism 500 is an optical element that combines optical images modulated for the respective color lights emitted from the emission side sheet polarizers and forms a color image. The cross dichroic prism 500 is formed in a substantial square shape obtained by bonding four rectangular prisms. Dielectric multi-layer films are formed on interfaces of a substantial X shape obtained by bonding the rectangular prisms. The dielectric multi-layer film formed on one interface of the substantial X shape reflects the red light and the dielectric multi-layer film formed on the other interface reflects the blue light. The red light and the blue light are bent by these dielectric multi-layer films and traveling direction of the red light and the blue light are aligned with a traveling direction of the green light. Consequently, the three color lights are combined.

The color image emitted from the cross dichroic prism 500 is expanded and projected by the projection optical system 600 and forms a large screen image on the screen SCR.

The projector 100 according to the fourth embodiment constituted as described above includes the optical element 1 according to the first embodiment. Thus, the projector 1000 according to the fourth embodiment is an excellent projector that is easily reduced in size and easily manufactured while reducing the deterioration in a polarization degree and uniformity of a light flux emitted from the optical element as much as possible.

The optical elements and the protector according to the embodiments of the invention have been explained. However, the invention is not limited to the embodiments. It is possible to carry out the invention in various forms without departing from the spirit of the invention. For example, modifications described below are also possible.

(1) In the optical elements 1 to 3 according to the first to third embodiments, the first rod section 10 and the second rod section 14 are made of the solid glass rod. However, the invention is not limited to this. A first rod section and a second rod section may be made of, for example, a hollow rod such as a tubular light tunnel obtained by bonding reflection surfaces of four reflection mirrors side by side to face the inner side. One of the first rod section and the second rod section may be made of the solid rod and the other may be made of the hollow rod. Alternatively, both the first and second rods may be made of the hollow rod.

(2) In the optical elements 1 to 3 according to the first to third embodiments, the respective optical components forming the optical element are bonded to one another. However, the invention is not limited to this. The respective optical components may be spaced apart from one another,

(3) In the optical elements 1 to 3 according to the first to third embodiments, the reflection inorganic sheet polarizer of the wire grid type in which a large number of fine metal thin wires are arrayed is used as the reflective polarization beam splitter 12 or the second reflective polarization beam splitter 22. However, the invention is not limited to this. A reflection polarization beam splitting element made of a dielectric multi-layer film and a reflection polarization beam splitting element made of an XY-type polarization film imparted with an XY-type polarization characteristic by stacking plural films having a biaxial directional property may be used.

(4) As the projector 1000 according to the fourth embodiment, the projector including the optical element 1 according to the first embodiment as the optical element is explained as an example. However, the invention is not limited to this. The projector 1000 may include the optical element 2 or 3 according to the second or third embodiment.

(5) In the projector 1000 according to the fourth embodiment, the sub-mirror is used as the reflecting means disposed in the light emitting tube. However, the invention is not limited to this. It is also preferable to use a reflection film as the reflecting means. As the projector 1000 according to the fourth embodiment, the projector in which the sub-mirror as the reflecting means is disposed in the light emitting tube is explained as an example. However, the invention is not limited to this. It is also possible to apply the invention to a projector in which a sub-mirror is not disposed.

(6) The -projector 1000 according to the fourth embodiment is a transmission projector. However, the invention is not limited to this. It is also possible to apply the invention to a reflection projector. Here, “transmission” means that an electro-optic modulator as light modulating means is a type for transmitting light in the same manner as a transmission liquid crystal device. “Reflection” means that an electro-optic modulator as light modulating means is a type for reflecting light in the same manner as a reflection liquid crystal device. It is possible to obtain effects same as those of the transmission projector when the invention is applied to the reflection projector.

(7) As the projector 1000 according to the fourth embodiment, the projector including the three liquid crystal devices 400R, 400G, and 400B is explained as an example. However, the invention is not limited to this. It is also possible to apply the invention to a projector including one, two, or four or more liquid crystal devices.

(8) It is also possible to apply the invention to a front projection projector that projects a projection image from an observation side. Further, it is also possible to apply the invention to a rear projection projector that projects a projection image from a side opposite to the observation side.

The entire disclosure of Japanese Patent Application No. 2006-323116, filed Nov. 30, 2006 is expressly incorporated by reference herein.

What is claimed is:

1. An optical element comprising:
a first rod section that converts an incident light flux into a light flux having a more uniform in-plane light intensity distribution;
a reflective polarization beam splitter that reflects a light flux related to one linearly polarization component of light fluxes from the first rod section and transmits a light flux related to the other linearly polarization component; and
a second rod section that converts the light flux transmitted through the reflective polarization beam splitter into a light flux having a more uniform in-plane intensity distribution.

2. An optical element according to claim 1, further comprising:
a reflection mirror that is arranged on a light incidence side of the first rod section and has an opening for light incidence in the center thereof; and
a λ/4 plate that is arranged between the reflection mirror and the first rod section.

3. An optical element according to claim 1, further comprising a reflection mirror that is arranged on a light incidence side of the first rod section and has an opening for light incidence in the center thereof.

4. An optical element according to claim 1, further comprising a second reflective polarization beam splitter that is arranged on an light incidence side of the first rod section, has an opening for light incidence in the center thereof, and transmits a light flux related to one linearly polarization component of light fluxes reflected on the reflective polarization beam splitter and reflected on an inner surface of the first rod section and reflects a light flux related to the other linearly polarization component.

5. A projector comprising an optical element according to claim 1.

6. A projector according to claim 5, further comprising:
a reflection mirror that is arranged on a light incidence side of the first rod section and has an opening for light incidence in the center thereof; and
a λ/4 plate that is arranged between the reflection mirror and the first rod section.

7. A projector according to claim 5, further comprising a reflection mirror that is arranged on a light incidence side of the first rod section and has an opening for light incidence in the center thereof.

8. A projector according to claim 5, further comprising a second reflective polarization beam splitter that is arranged on an light incidence side of the first rod section, has an opening for light incidence in the center thereof, and transmits a light flux related to one linearly polarization component of light fluxes reflected on the reflective polarization beam splitter and reflected on an inner surface of the first rod section and reflects a light flux related to the other linearly polarization component.
